(19) United States
(12) Patent Application Publication
(10) Pub. No.: US 2024/0220903 A1
(43) Pub. Date: Jul. 4, 2024

(54) SYSTEM AND METHOD TO CALCULATE PURSUIT EFFECTIVENESS SCORE

(71) Applicant: NICE LTD., Ra'anana (IL)

(72) Inventors: Aniruddha PHADNIS, Atlanta, GA (US); Nao SHLOMO, Atlanta, GA (US)

(21) Appl. No.: 18/149,753

(22) Filed: Jan. 4, 2023

(51) Int. Cl. G06Q 10/0639

(52) U.S. Cl. CPC G06Q 10/06393

(57) ABSTRACT

Methods and systems of utilizing pursuit effectiveness scores to implement targeted employee training, provide specific employee feedback, improve employee training, and enhance employee motivation efforts. Gamification tactics, known as pursuits, are created with one or more key performance indicators (KPIs) to motivate customer service agents to perform well on the KPIs, evaluate agent engagement, and identify potential strengths and weaknesses for one or more agents. By utilizing a change score, completion score, and speed score for a pursuit, actionable insights can be generated for meaningful training and feedback actions while creating new pursuits on the same or similar objectives, assigning coaching programs, increasing the accuracy of pursuits with object calibration, identifying agents that require additional training, identifying agents that are excelling and may be potential mentors or role models for certain KPIs, and other actions related to the pursuit effectiveness.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of calculating a pursuit effectiveness score, and more specifically relates to methods and systems of utilizing pursuit effectiveness scores to implement targeted employee training, provide specific employee feedback, improve employee training, and enhance employee motivation efforts.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Contact center supervisors, managers, and other leaders perform a variety of roles, including managing agent engagement, performance, training, and development. However, due to a wide array of responsibility and agents to monitor, train, or otherwise engage with, supervisors are not able to dedicate all of their time and effort to managing agent engagement. Accordingly, supervisors need fast, efficient, and effective ways to boost agent engagement and performance, identify training needs, assign training, and otherwise assist agent performance and development. Supervisors incorporate gamification-gaming tactics meant to motivate employees—as a method of increasing agent engagement and motivation, identifying agent training needs, assigning training plans, and otherwise developing agents.

In contact centers, agents are evaluated using key performance indicators (KPIs). In a contact center, KPIs may include average handle time, customer satisfaction, agent productivity, no speech time, cross talk time, agent effectiveness and engagement, revenue, and the like. Gamification tactics, known as pursuits (a challenge or game), are created with one or more KPIs in mind to motivate agents to perform well on the KPIs, evaluate agent engagement, and identify potential strengths and weaknesses for agents. Pursuits provide opportunities to motivate agents, increase agent engagement, and may provide insight into training needs for agents. However, each pursuit is not equally effective in general, and different agents may see varying success with different pursuits. Supervisors do not have much time each day to dedicate to planning and assigning gamification and pursuits, yet need to provide simple ways to motivate an agent or team of agents when agents are not reaching their goal KPIs or their skills are subpar. Additionally, supervisors do not conventionally obtain any meaningful insights from pursuits for coaching creation, similar pursuit creation, objective calibration, or identifying potential mentors or champions on important KPIs.

Generally, supervisors or managers are tasked with the creation of pursuits for their teams. The creation of a pursuit is challenging, as creating an effective pursuit requires the analysis and utilization of a significant amount of data for individuals, teams, and/or an organization.

Accordingly, there is a need to calculate the effectiveness of pursuits, develop effective pursuits, and provide pursuit information, training recommendations, and other information to supervisors without adding additional burden to supervisors.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2A is an exemplary diagram of the relationship of factors utilized in determining a pursuit effectiveness score.

FIG. 2B is an exemplary diagram of the relationship between scoring thresholds for a pursuit effectiveness score, automated actions, and insights.

FIG. 3 is an exemplary diagram of an exemplary flowchart for determining a pursuit effectiveness score by evaluating a call center agent.

FIG. 4 is a simplified diagram of data flow in an exemplary system environment according to some embodiments.

FIG. 5 is an exemplary flowchart for determining pursuit effectiveness scores for a team of agents.

FIG. 6 is a simplified diagram of a computing device according to some embodiments.

FIG. 7A is an example embodiment of a system implementing a gamification solution which is enhanced to calculate pursuit effectiveness scores and provide corresponding output, such as actionable insights.

FIG. 7B is an example of the insights and actions automator, according to some embodiments.

FIG. 8A is an exemplary graph for viewing the pursuit effectiveness scores of agents on a team and a team average, according to some embodiments.

FIG. 8B is an exemplary table for viewing the pursuit effectiveness scores of agents on a team, a team average, and actionable insights, according to some embodiments.

FIG. 8C is an exemplary user interface for a team leader to view pursuit effectiveness scores and related data, according to some embodiments.

FIG. 8D is an exemplary user interface for interacting with actionable insights generated by a system utilizing pursuit effectiveness scores, according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein describe systems and methods for calculating a pursuit effectiveness score. Pursuits require objectives that are achievable for the workforce, but not be too simple to achieve as to provide no motivation to employees. In some instances, pursuits may need to be customized for employees who perform above or below average. Accordingly, the creation of pursuits is tedious, time-consuming, and error-prone.

Effective pursuits provide significant benefit. Pursuits motivate employees and provide a measurable way to develop and/or to evaluate employee growth or progression, achievement, and strengths and weaknesses. Additionally, actionable insights can be generated for supervisors and managers that allow them to take meaningful actions while creating new pursuits on the same or similar objectives, assigning coaching programs, increasing the accuracy of pursuits with object calibration, identifying agents that require additional training, identifying agents that are excelling and may be potential mentors or role models for certain key performance indicators (KPIs), developing additional pursuits for a given skill set or pool of agents, and other actions related to the pursuit effectiveness.

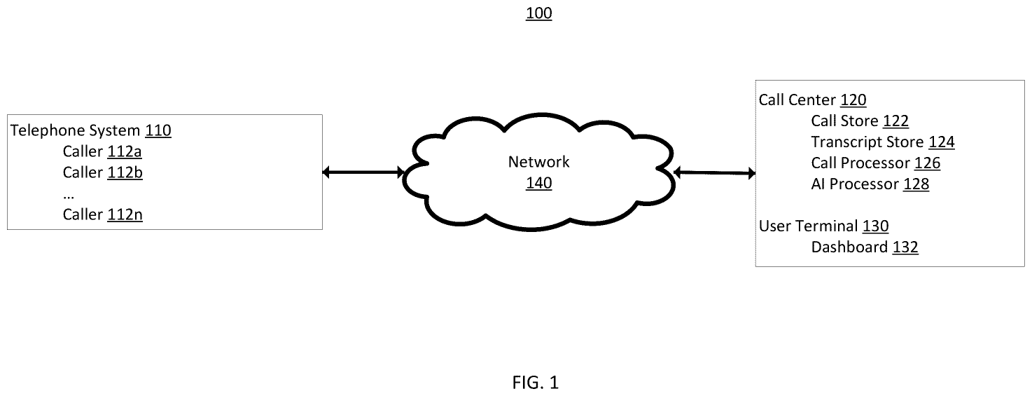

FIG. 1 illustrates a block diagram of an example environment 100 according to some embodiments. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML, neural network (NN), and other AI architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

FIG. 1 illustrates a block diagram of an example environment 100 according to some embodiments. Environment 100 may include a telephone system 110 and a call center 120 that interact to provide call center services to customers via a network. In other embodiments, environment 100 may not have all the components listed and/or may have other elements instead of, or in addition to, those listed above, or may involve a different service than that of a call center. In some embodiments, the environment 100 is an environment in which agent KPIs may be determined through an ML or other AI system. As illustrated in FIG. 1, call center 120 might interact via a network 140 with callers 112a-112n in telephone system 110, to collect agent performance data, ingest and analyze agent performance data, determine KPIs associated with agent performance data, generate pursuit effectiveness scores for agents, and generate actionable insights for agents and supervisors.

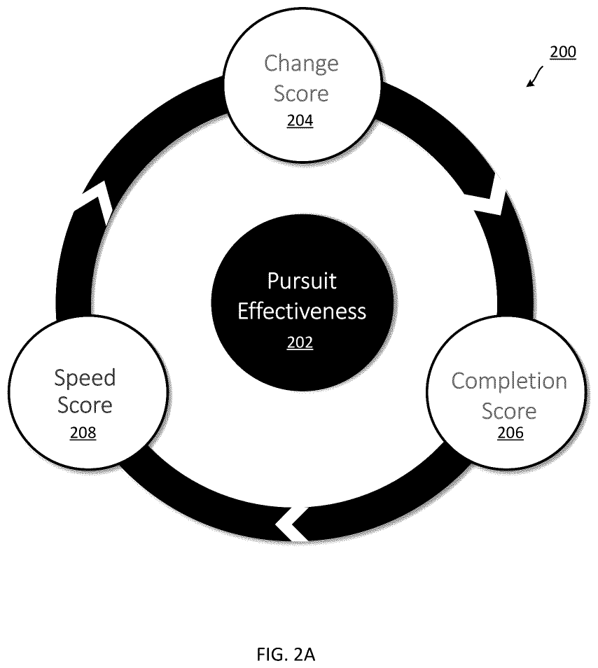

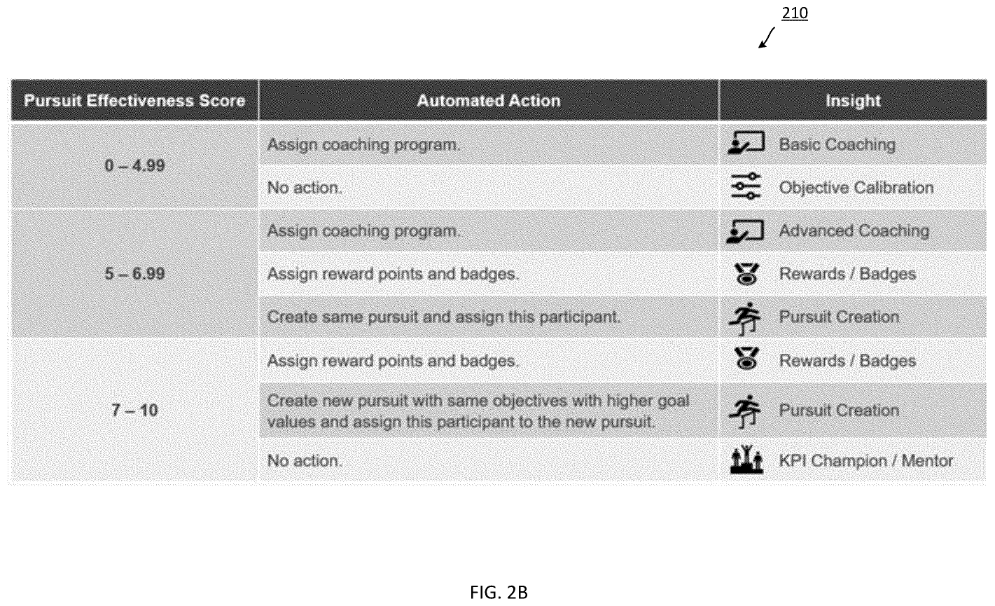

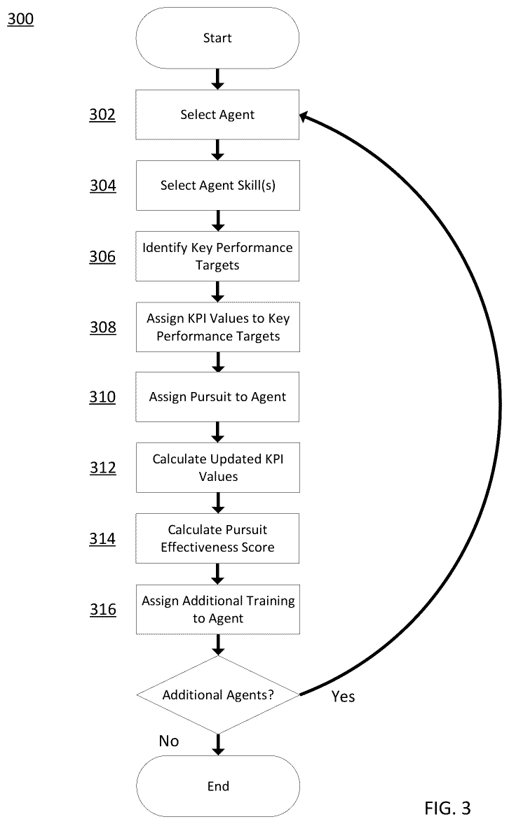

In some embodiments, call center 120 may include a call store 122, transcript store 124, call processor 126, and/or other components to collect and store agent performance data to ingest for analysis. These elements of the call center 120 may individually or collectively store call information and metrics related to individual calls, calls by a specific customer, calls answered by a specific agent, or other information or metrics. Call center 120 may further utilize an AI processor 128 to collect metrics and data, or to utilize call information or metrics collected by one or more of call store 122, transcript store 124, and call processor 126. For instance, AI processor 128 may be in communication with user terminal 130 to directly capture statistics, information, and metrics related to an agent's performance, or alternatively may be in communication with one or more of call store 122, transcript store 124, and call processor 126 to collect statistics, information, and metrics collected regarding an agent. This information may be collected initially to determine KPIs for each applicable agent, or may be continuously collected during employment to monitor and evaluate agent performance and progression, and to determine KPIs after the completion of a pursuit, generate pursuit effectiveness scores for agents, or generate actionable insights that may be used by a supervisor to evaluate or train one or more agents, as discussed further below with respect to FIGS. 2A and 3. It should be understood that references to a single agent herein may generally refer to one or more agents.

In some embodiments, AI processor 128 may further include a neural network or other machine learning system to receive, process, generate KPI values, and provide actionable insights for supervisors. In such embodiments, AI processor 128 may consider the KPI values, pursuit effectiveness score, or any other inputs, to identify and better tailor AI processor 128 for efficiently monitoring and evaluating agent performance and progression, determining KPIs after the completion of a pursuit, generating pursuit effectiveness scores for agents, or generating actionable insights that may be used by a supervisor to evaluate or train an agent.

Several elements in the system shown and described in FIG. 1 include elements that are explained briefly here. For example, the user terminal 130 could include a desktop personal computer, workstation, laptop, notepad computer, PDA, cell phone, or any wireless access protocol (WAP) enabled device or any other computing device capable of interfacing directly or indirectly to the Internet or other network connection. The user terminal 130 may also be a server or other online processing entity that provides functionalities and processing to other user terminals or programs, such that an agent may perform their duties at call center 120 and interact with callers 112a-112n over network 140.

The user terminal 130 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, the client devices and all of its components are configurable using applications, such as a browser, including computer code run using a central processing unit such as an Intel Pentium® processor or the like. However, user terminal 130 may instead correspond to a server configured to communicate with call center 120 or callers 112a-112n, for interaction with the user terminal 130 in order to perform call center duties in a manner which may be monitored by user terminal 130, stored in call store 122 and transcript store 124, processed by call processor 126, and analyzed by AI processor 128. In all embodiments herein, the disclosure may be directed to an analytics center that collects input from and resultant data to a call center.

Thus, call center 120, user terminal 130, and all of their components might be operator configurable using application(s) including computer code to run a central processing unit, which may include an Intel Pentium® processor or the like, and/or multiple processor units. A server for call center 120 and/or user terminal 130 may correspond to a Windows®, Linux®, or the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring call center 120 and/or user terminal 130 to intercommunicate and to process and collect data related to calls placed with callers 112a-112n over network 140 as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

FIG. 2A shows an exemplary diagram 200 of the relationship of factors utilized in determining a pursuit effectiveness score 202. Pursuits are typically multi-level challenges created on top of performance KPIs, which aim to motivate employees into achieving higher performance goals and help an organization in achieving its business objectives. In some pursuits, employees may be awarded reward points and badges for the completion of a pursuit, completion of a level of a pursuit, achieving KPIs or other key milestones during a pursuit, setting record performance statistics during a pursuit, or reaching other goals or achievements during a pursuit. This helps to motivate employees to perform better, and more consistently, benefiting both employees and supervisors or management.

The pursuit effectiveness score 202 measures the effectiveness of a pursuit for a participant, group of participants, team, or some other subset of one or more individuals. To evaluate the effectiveness of a pursuit, multiple factors are considered. For instance, one factor may query how much the pursuit has impacted KPI values for employees participating in the pursuit. For pursuits targeting specific KPI values, the change in KPI values over the duration of the pursuit can show the effectiveness of the pursuit on a single employee or the effectiveness of the pursuit as a whole with regard to a specific KPI value. Another factor may query how many pursuit levels participants have successfully completed. A pursuit that is completed fully by each employee is an effective pursuit, while a lower degree of completion may indicate issues with the pursuit as a whole, or with the benefit of that pursuit for a specific employee. A third factor may query how quickly participants have completed the pursuit. A fast completion time by a number of employees may indicate that a pursuit is too easy, while faster or slower competition by specific employees may indicate strengths or weaknesses of the employee, identify areas requiring additional training, or otherwise may flag useful information for a supervisor. Accordingly, when a pursuit is scored, the pursuit effectiveness score 202 is based on a weighted average of a change score 204, a completion score 206, and a speed score 208. A formula for calculating a pursuit effectiveness score is:

$$Pursuit Effectiveness = \frac{\begin{matrix}( {weight}_{Change Score} \times Change Score ) + ( {weight}_{Completion Score} \times \\ Completion Score ) + ( {weight}_{Speed Score} \times Speed Score )\end{matrix}}{{weight}_{Change Score} + {weight}_{Completion Score} + {weight}_{Speed Score}}$$

In the above formula, the change score is change score 204, the unified scaled score of the change in KPI values of a pursuit, as detailed further below. The completion score is the completion score 206, the scaled score of the levels completed in a pursuit, as detailed further below. The speed score is the speed score 208, the scaled score of the pursuit completion score, as detailed further below. Accordingly, the weight_{Change Score} is the weight assigned to the change score 204, the weight_{Completion Score} is the weight assigned to the completion score 206, and the weight_{Speed Score} is the weight assigned to the speed score 208. While any weights may be assigned to the change score 204, completion score 206, and speed score 208, in some embodiments, the weights are assigned according to the importance of each factor. For instance, if the change score is deemed more important than the completion score, and the completion score is deemd more important than the speed score, than the weight_{Change Score} may be larger than the weight_{Completion Score}, and both weights may be larger than the weight_{Speed Score}.

The change score 204 represents a change in KPI values from before and after competition of the pursuit. This represents how much of an impact the pursuit has created on the KPI values that it is targeting to improve, and is an important factor in determining the effectiveness of a pursuit. The change score 204 may be based on the change of a single KPI value, or the change in multiple KPI values targeted as a part of the pursuit or relevant to the pursuit. Accordingly, a baseline KPI value for each KPI should be collected before the pursuit begins. In some embodiments, the change score 204 comprises a unified scaled score of change in the KPI values for one or more of the key performance targets for an agent over the duration of the pursuit. The change score 204 represents the impact that a pursuit has created on the KPI values that it is intended to improve. An example of a formula for calculating a change score, utilizing a scaling factor as shown in Table 1 below, is:

$$Change Score = \frac{{\sum }_{i = 1}^{n} {weight}_{i} \times Scaling {Factor}_{i}}{{\sum }_{i = 1}^{n} {weight}_{i}}$$

TABLE 1

| Percent Change for KPI Value | Scaling Factor |
|---|---|
| 80%-100% or More | 10 |
| 60%-79% | 9 |
| 40%-59% | 8 |
| 20%-39% | 7 |
| 0%-19% | 6 |
| (−19%)-(−1%) | 5 |
| (−39%)-(−20%) | 4 |
| (−59%)-(−40%) | 3 |
| (−79%)-(−60%) | 2 |
| (−99% or Less)-(−80%) | 1 |

In the above formula and Table 1, the degree of change is the percentage change in KPI value of a monitoring period from before the start of the pursuit and after the completion of the pursuit. This may be calculated using a variety of calculation types as needed. For instance, for some KPIs or in some pursuits, an average may be utilized, while for other KPIs or in other pursuits, a sum or count may be used instead. The change score is the change score 204, the weighted average of scaling factor values of all relevant KPIs from the pursuit. The weightᵢ is the weight of a specific KPI. The scaling factorᵢ is the number derived based on the range in which the degree of change falls in Table 1. The monitoring period is a duration of any amount of time for which KPI values are monitored.

In some instances, KPI values may be measured such that lower values are better. For example, this may be the case for a time-based KPI, where a shorter, faster time is better than a longer, slower time. An example of a formula for a KPI where a lower value is better is:

$$Degree of {Change}_{LiB KPI} = \frac{\begin{matrix}Avg ( Aggregated KPI values before pursuit ) - \\ Avg ( Aggregated KPI values after pursuit )\end{matrix}}{Avg ( Aggregated KPI values before pursuit )} \times 100$$

In other instances, KPI values may be measured such that higher values are better. For example, this may be the case for a satisfaction-based KPI, where higher customer satisfaction is better than lower customer satisfaction. An example of a formula for a KPI where a higher value is better is:

$$Degree of {Change}_{HiB KPI} = \frac{\begin{matrix}Avg ( Aggregated KPI values after pursuit ) - \\ Avg ( Aggregated KPI values before pursuit )\end{matrix}}{Avg ( Aggregated KPI values before pursuit )} \times 100$$

of change for one or more KPI values may be obtained for each KPI value targeted by the pursuit. In some embodiments, once the degree of change for each relevant KPI is derived, it is replaced with a scaling factor based on the percentage degree of change. The change score 204 is then derived as a weighted average of the scaling factor values of each relevant KPI. In some embodiments, weights may defined for each KPI to give disproportionate value to certain or all KPIs, based on targeted goals for an agent, supervisor decisions, or some other input to assign different value to each KPI. In other embodiments, each KPI will be treated as having the same weight.

The completion score 206 represents a degree of completion of the pursuit. This score evaluates how many pursuit levels were successfully completed over the direction of the pursuit. The completion score 206 allows credit to be given to agents who have completed some degree of a pursuit without completing the entire pursuit. A pursuit may be made up of one or more levels where each level provides incremental targets to an agent. Each level may have specific associated goals, or may build on previous levels. In instances where an agent does not complete an entire pursuit, it is still beneficial to determine a pursuit effectiveness score 202 for the amount of the pursuit that has been completed. Accordingly, the completion score 206 allows the amount of the pursuit that has been completed to impact the pursuit effectiveness score 202. An example of a formula for calculating a completion score, utilizing a calculated degree of completion as shown in Table 2 below, is:

$$Degree of Completion = \frac{Completed Levels}{Total Levels} \times 100$$

TABLE 2

| Degree of Completion | Completion Score |
|---|---|
| 91%-100% | 10 |
| 81%-90% | 9 |
| 71%-80% | 8 |
| 61%-70% | 7 |
| 51%-60% | 6 |
| 41%-50% | 5 |
| 31%-40% | 4 |
| 21%-30% | 3 |
| 11%-20% | 2 |
| 1%-10% | 1 |
| 0% | 0 |

In the above formula and Table 2, the completion score 206 is the scaling factor in which the degree of completion value falls. The degree of completion is the percentage value of the number of levels completed in a pursuit. The completed levels represents the number of levels completed by an agent in a pursuit, while the total levels represents the total number of levels in the pursuit.

The speed score 208 represents the score with which the pursuit was completed. This score evaluates how fast the pursuit levels were successfully completed. The speed score 208 may be a measurement of the days, hours, or some other unit of time in which an agent took to complete the pursuit. This will calculate the duration from the start of the pursuit, or the point at which the pursuit was assigned to an agent, to the point in which the pursuit was completed. In some embodiments, the speed score 208 will be weighted at zero if the agent does not fully complete the pursuit, where the speed score 208 represents a score for the completion of the entire pursuit as opposed to one or more levels of the pursuit. The speed score 208 may also be based entirely, or partly, on the actual time engaged in completing the pursuit, irrespective of the time period over which the pursuit is conducted and completed. An example of a formula for calculating a speed score, utilizing a calculated duration of completion as shown in Table 3 below, is:

$$Duration of Completion = \frac{( Pursuit Completition in Days )}{( Pursuit Duration in Days )} \times 100$$

TABLE 3

| Duration of Completion | Speed Score |
|---|---|
| 91%-100% | 1 |
| 81%-90% | 2 |
| 71%-80% | 3 |
| 61%-70% | 4 |
| 51%-60% | 5 |
| 41%-50% | 6 |
| 31%-40% | 7 |
| 21%-30% | 8 |
| 11%-20% | 9 |
| 1%-10% | 10 |
| 0% | 0 |

In the above formula and Table 3, the speed score 208 is the scaling factor in which the duration of completion value falls. The duration of completion is the percentage value of the number of days/weeks/some other time measurement compared to the duration of the pursuit in the same time measurement.

A pursuit effectiveness score 202 is calculated for a single pursuit for a single participant. When measuring the effectiveness of a pursuit for a group of participants, team, or some other subset of one or more individuals, a pursuit effectiveness score 202 should be calculated for each individual. A team average is then determined for the team of individuals. In some embodiments, a team report is generated, where each agent on a team of agents is compared to the team average. Such reports provide valuable and actionable insights to supervisors for actions such as coaching creation, similar pursuit creation, objective calibration, evaluating a team of agents, and identifying stronger or weaker agents.

In some embodiments, a pursuit effectiveness score 202 is calculated after the earlier of when the pursuit end date is elapsed or when the pursuit is completed by the agent, and the monitoring period is also elapsed after the pursuit end date or pursuit completion date.

FIG. 3 shows an exemplary diagram 300 of an exemplary flowchart for determining a pursuit effectiveness score for a pursuit.

At step 302, an agent is selected from a plurality of call center agents. While pursuit effectiveness scores can be calculated for multiple agents, a team of agents, or some other subset of one or more agents, each agent will have an individualized associated pursuit effectiveness score. Accordingly, when determining a pursuit effectiveness score for a pursuit, the score is calculated for a single agent, where the score is unique to that specific agent. This is because a pursuit score depends on individualized factors, such as KPI values for a specific agent, as discussed in further detail below.

At step 304, one or more agent skills are selected from a plurality of agent skills assigned to the call center agent. These skills may be determined by a supervisor, manager, or some other party evaluating the call center agent. Each skill may be directly related to areas of performance for which the agent is being evaluated. Alternatively, the skills may be determined by a processor based on previous pursuits, the selected agent, or other factors related to the pursuit.

At step 306, key performance targets are identified for the agent. In some embodiments, these key performance targets may be directly related to the selected agent skills. These key performance targets may include average handle time (the time taken by a call), first call resolution (whether an agent addresses a customer's need in the first call), agent productivity (the output of the agent throughout the day), sentiment, customer satisfaction, no speech time, cross talk time, or other measurable or quantifiable attributes related to an agent's performance

At step 308, key performance indicator (KPI) values are assigned to one or more of the key performance targets for the agent. These KPI values represent the current status of the agent's performance with relation to the identified key performance targets. For example, a new agent may have a longer average handle time for a specific type of customer, while a more experienced agent should have (or be expected to have) a shorter average handle time. Thus, the KPI values assigned to a given agent may reflect of that agent's particular past performance or expected performance.

At step 310, a pursuit is assigned to the agent targeting one or more of the key performance targets. The pursuit may invoke various gaming tactics meant to motivate employees as a method of increasing agent engagement and motivation, identifying agent training needs, assigning training plans, or otherwise developing agents.

At step 312, after the pursuit has been completed, the KPI values for one or more of the key performance targets are calculated to determine the change in the KPI values from before the pursuit began to after the pursuit was completed.

At step 314, a pursuit effectiveness score is assigned to the pursuit. When a pursuit is scored, the pursuit effectiveness score is based on a weighted average of a change score, a completion score, and a speed score. The change score represents a change in KPI values from before and after competition of the pursuit, as a measurement of how much of an impact the pursuit has created on the KPI values that it is targeting to improve. The completion score represents a degree of completion of the pursuit, as a measurement of how many pursuit levels were successfully completed over the direction of the pursuit. The speed score represents the score with which the pursuit was completed, as a measurement of how fast the pursuit levels were successfully completed.

At step 316, additional training is assigned to the agent based on the pursuit effectiveness score. This additional training may be targeted based on specific weaknesses identified through the pursuit, may be due to a low pursuit effectiveness score, or may be due to a combination of factors related to the pursuit effectiveness score and underlying components.

In some embodiments, one or more scoring thresholds are assigned to the pursuit, and additional training or other further action is taken based on where the pursuit effectiveness score falls in relation to the one or more scoring thresholds. Automated actions or insights may be generated using the scoring thresholds, mentors or KPI champions may be identified using the scoring thresholds, and supervisors or managers may utilize scoring thresholds to quickly and effectively communicate information related to an agent's performance. An example of how automated actions may be assigned to various pursuit effectiveness scores falling within scoring thresholds is shown in table 210 in FIG. 2B.

In one embodiment, where three scoring thresholds are determined for a pursuit, different actions may be taken depending on where a pursuit effectiveness score falls. For instance, a pursuit effectiveness score falling within the lowest scoring threshold may result in action such as assigning basic coaching for the agent on KPI values requiring improvement, modification to the pursuit to provide the agent with an easier pursuit in the future and provide better-calibrated objectives, or simply taking no action to reward the agent. By calibrating pursuit objectives to decrease the difficulty of the pursuit by using simpler objective values, the objectives in the pursuit will be more attainable and the agent will be encouraged to achieve the pursuit goals through improved performance. A pursuit effectiveness score falling within the middle scoring threshold may result in action such as assigning advanced coaching for the agent on KPI values that could be improved further, assigning reward points or badges for the agent for KPI values which improved by a significant amount, and creating a pursuit of similar difficulty. A pursuit effectiveness score falling within the upper scoring threshold may result in action such as assigning reward points or badges for the agent for the KPI values which improved by a significant amount, assigning reward points or badges for the agent for the KPI values for which the agent had the best performance, creating a new pursuit with higher goal values to increase the difficulty of future pursuits, identifying the agent as a potential KPI champion or mentor, or a combination thereof.

When pursuit effectiveness scores are desired for multiple agents, a team of agents, or some other subset of one or more agents, the evaluation set out in steps 302-314 may be repeated any number of times for any number of agents. For instance, a supervisor may determine that a team is underperforming in one or more KPI values and implement a pursuit to improve the team's performance for the KPI values. In some embodiments, each agent on the team (or relevant subset of a team, such as agents with a particular range of experience) may be assigned the same pursuit targeting the same KPI values. This allows the team to be compared against one another, allows team averages to be determined, and allows for the identification of overperforming or underperforming agents on the team based on the assigned pursuit. In other embodiments, agents may initially be assigned customized pursuits based on current KPI values, previous KPI values, previous pursuit effectiveness scores, or some other metric determined by a supervisor, manager, or some other interested, authorized party.

When pursuit effectiveness scores are determined for multiple agents, a team of agents, or some other subset of one or more agents, modifications may be made to the pursuit for one or more agents based on the team average. For instance, the modifications may include calibrating objective values to make objectives attainable for an agent, where a pursuit effectiveness score falls within certain scoring thresholds, while the modifications may include calibrating objective values to increase the difficulty of future pursuits assigned to an agent, where a pursuit effectiveness score falls within a higher scoring threshold.

In some embodiments, the pursuit effectiveness score may be used to determine potential mentors or champions on important KPIs. For instance, when pursuit effectiveness scores are determined for multiple agents, a team of agents, or some other subset of one or more agents, the agent scoring the highest of all of the agents may be identified as a potential mentor or champion for the KPI for which they show the best performance, or best degree of improvement.

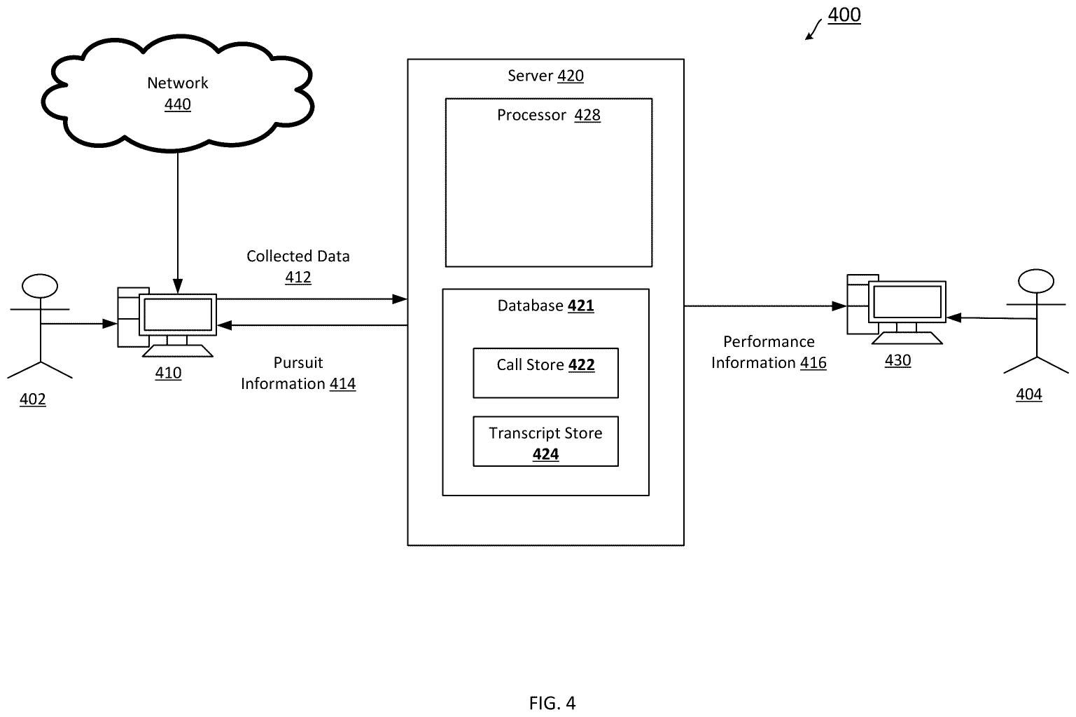

FIG. 4 is a simplified diagram of data flow in an exemplary system environment 400 according to some embodiments. Environment 400 of FIG. 4 includes one or more of an agent 402, a supervisor 404, an agent client 410, a supervisor client 430, a server 420, a processor 428, and a network 440. In some embodiments, processor 428 may utilize artificial intelligence or machine learning, and accordingly correspond to AI processor 128 as discussed in reference to FIG. 1. Server 420 may further include a database 421 that stores call information in a call store 422 and/or a transcript store 424. Network 440 may correspond to network 140 as discussed in reference to FIG. 1, where agent 402 interacts with callers through the network 440. Accordingly, collected data 412 related to call metrics, performance information, or other relevant information may be collected and sent to server 420, where it is stored in database 421 in call store 422 and/or transcript store 424. This may include performance information for agent 402 such as average handle time, first call resolution, sentiment, customer satisfaction, no speech time, cross talk time, productivity, or other measurable or quantifiable attributes related to the agent's performance. When a pursuit is assigned to agent 402, corresponding pursuit information 414 will be sent to the agent from server 420. This may include feedback for agent 402, an updated pursuit implementing modifications or objective calibration, or rewards or badges for employee 402.

Server 420, and specifically processor 428, may utilize collected data 412, stored in database 421, to determine KPIs for one or more key performance targets for agent 402 when determining a pursuit effectiveness score. Performance information 416 is provided to supervisor 404. This may include actionable insights for supervisor 404 for actions such as coaching creation, similar pursuit creation, objective calibration, evaluating a team of agents, and identifying stronger or weaker agents, as well as information related to actions taken by processor 428 in relation to the pursuit and pursuit modifications or objective calibration.

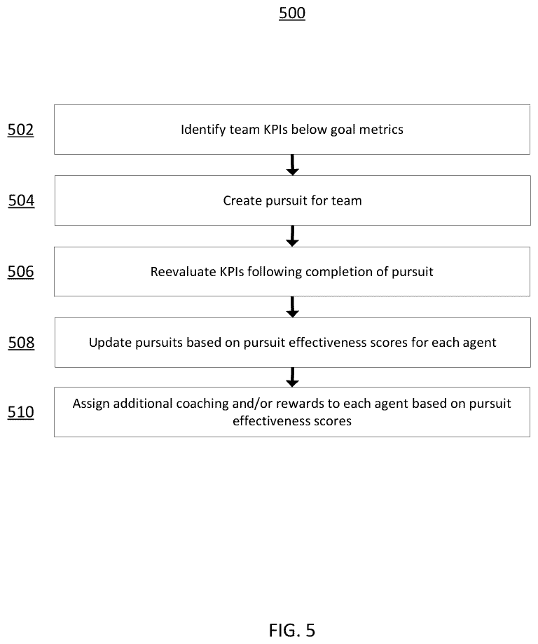

FIG. 5 is an exemplary flowchart 500 for determining pursuit effectiveness scores for a team of agents. Note that one or more steps, processes, and methods described herein of flowchart 500 may be omitted, performed in a different sequence, or combined as desired or appropriate based on the guidance provided herein. Flowchart 500 of FIG. 5 includes operations for determining pursuit effectiveness scores for a team of agents, as discussed in reference to FIGS. 1-4. One or more of steps 502-510 of flowchart 500 may be implemented, at least in part, in the form of executable code stored on non-transitory, tangible, machine-readable media that when run by one or more processors may cause the one or more processors to perform one or more of steps 502-510. In some embodiments, flowchart 500 can be performed by one or more computing devices discussed in environment 100 of FIG. In various embodiments, a supervisor, manager, or individual in charge of one or more agents may determine that a team of agents are collectively performing below their goals. In some embodiments, the determination may instead be made by a processor utilizing artificial intelligence or machine learning.

Accordingly, at step 502 of flowchart 500, a supervisor, manager, individual in charge of a team of agents, AI processor, or some other interested party may identify team KPIs below the targeted goal metrics. This may include one or more KPIs, such as average handle time, first call resolution, sentiment, customer satisfaction, no speech time, cross talk time, productivity, or other measurable or quantifiable attributes related to an agent's performance.

At step 504, a new pursuit may be created for the team of agents. By assigning a pursuit to the team of agents, the agents may be motivated and improve their performance. Additionally, the pursuit allows for a measurable way to evaluate the growth or progression, achievement, strengths, and weaknesses of each agent on the team. The pursuit may contain the same goals for each agent on the team, or may have goals tailored to each individual agent based on previous pursuits, measured KPI values, or some other determination. In some embodiments, each agent will receive a pursuit oriented towards improving the same KPI values, in order to increase team performance on the KPI values, and ensure consistency between assigned pursuits for each agent on the team.

At step 506, team performance is evaluated following the completion of the pursuit. KPI values for each of the targeted goal metrics are reevaluated to determine the impact that the pursuit has had on each KPI value. A pursuit effectiveness score for each agent is calculated using the new KPI values.

At step 508, the pursuit is updated for each agent on the team of agents based on the respective pursuit effectiveness scores. Objective calibration may be performed on the pursuit to better tailor the pursuit to each agent. As discussed above in relation to FIG. 3, after determining the pursuit score, the system may determine one or more thresholds on which to evaluate the employees participating in the pursuit. These thresholds may be predetermined, determined by the system, determined by a supervisor, or determined by some other party. The thresholds may be unique to a single agent or standardized for each agent participating in the pursuit.

In some embodiments, objective calibration may be performed by the system based on the performance of an agent, multiple agents, or a team of agents. Insight may be provided to a supervisor, manager, or other authorized party to calibrate objective values. For example, an expert consultant or analytics provider operating the system might be such an authorized party. The system may also calibrate objective values without input from an external source. For agents scoring in lower performance zones, objective calibration may comprise simplifying objective values in future pursuits which are similar or the same. This makes objectives more attainable for agents and encourages the participation of agents to achieve the objectives set out in the pursuit by increasing performance. For agents scoring in higher performance zones, objective calibration may comprise making objective values more complex in future pursuits which are similar or the same, to avoid scenarios where the pursuit is too simple and thus fails to motivate agents.

At step 510, additional actions are assigned to each agent based on the pursuit effectiveness scores. The system may then provide tangible objectives, goals, training, or feedback for each employee based on whether the employee scores below one or more set thresholds, between set thresholds, or above one or more set thresholds. In one embodiment, the system may set three “performance zones” using two thresholds, where the first performance zone represents a score that is below both thresholds, the second performance zone represents a score between the two thresholds, and the third performance zone represents a score above both thresholds. Accordingly, the system may provide different outputs for each agent depending on which performance zone their pursuit score falls. In some embodiments, the system may adjust the pursuit for a single agent or for all agents based on which performance zone each agent scored in during a previous pursuit.

In some embodiments, coaching or training may be assigned to agents based on the performance zone in which their pursuit score falls. The coaching or training is assigned to target the same performance KPIs measured and targeted by the pursuit. Additional insight may be generated and provided to the agent, a supervisor, managers, or any other authorized party that may benefit from the additional information. The coaching or training may be modified by the system or by a supervisor or manager to tailor the coaching or training to a specific agent. In some embodiments, agents scoring in higher performance zones may be assigned advanced training, while agents scoring in lower performance zone may be assigned basic training and/or more training than the agents scoring relatively higher. Advanced training may provide additional, more complex, or otherwise more advanced training to agents, while basic training may provide baseline or more simple training to agents.

In some embodiments, rewards or badges may be assigned to agents based on the performance of an agent, multiple agents, or a team of agents. The system may award reward points to agents for achieving goals, hitting KPI targets, completion of pursuit levels, or other milestones over the course of the pursuit. The system may alternatively award badges to agents for hitting KPI targets, achieving goals, completing a pursuit level, completing the entire pursuit, or reaching other milestones over the course of the pursuit. The system may also generate insights for a manager, supervisor, agent, or other party so that they can award additional reward points, badges, or other awards to agents for performance.

In some embodiments, the system may identify an agent, multiple agents, or a team of agents as KPI champions, potential mentors, potential leaders, or other insights based on the identified potential of agents based on their performance in pursuits. For instance, an agent scoring above a set threshold or multiple thresholds may be identified as a candidate to provide mentorship, training, or other leadership to agents performing under set thresholds for a specific KPI. An agent scoring above set thresholds for multiple KPIs may be identified as a candidate to provide mentorship, training, or other leadership to agents on a more general level.

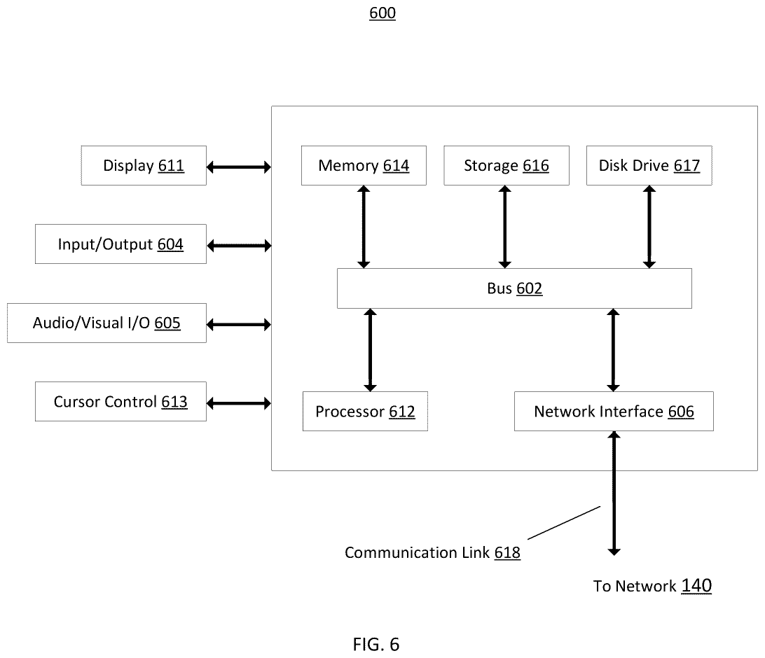

As discussed above and further emphasized here, FIGS. 1, 2, 3, 4, and 5 are merely examples of environment 100 and corresponding methods for utilizing pursuit effectiveness scores to implement targeted employee training, provide specific employee feedback, improve employee training, and enhance employee motivation effort, which examples should not be used to unduly limit the scope of the claims. One of ordinary skill in the art would recognize many variations, alternatives, and modifications based on the guidance presented herein. FIG. 6 is a block diagram of a computer system suitable for implementing one or more components in FIG. 1, according to an embodiment. In various embodiments, the communication device may include a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers, such as user terminal 130, may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). Display 611 and cursor control 613 may operate to allow users to interact with dashboard 132. An optional audio/visual input/output component 605 may also be included to allow a user to use voice for inputting information by converting audio signals. Audio/visual I/O component 605 may allow the user to hear audio, and well as input and/or output video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that include bus 602. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

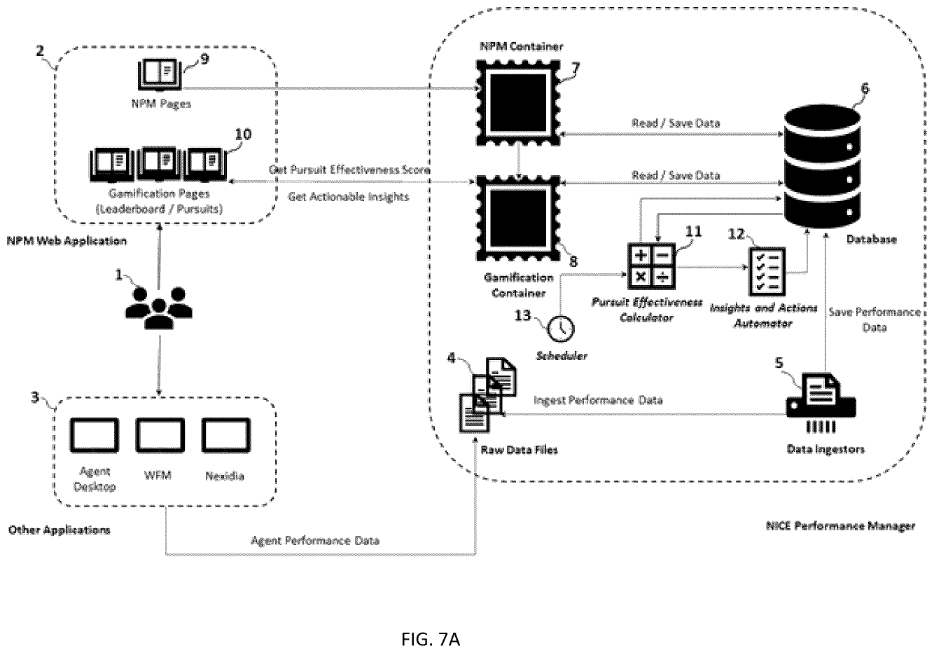

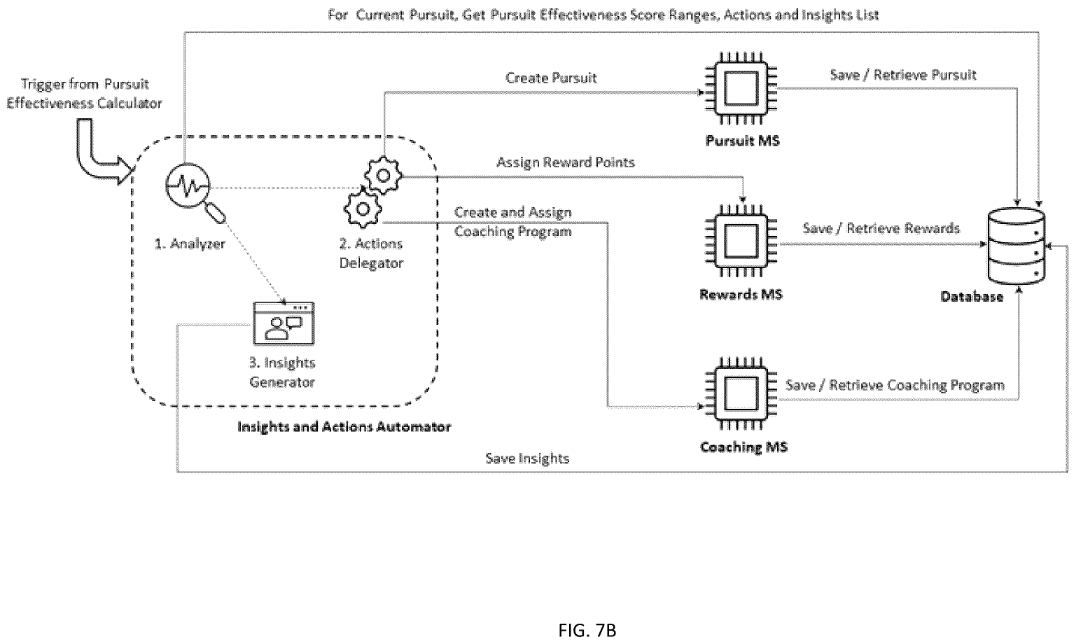

FIG. 7A is an example embodiment of a system implementing a gamification solution which is enhanced to calculate pursuit effectiveness scores and provide corresponding output, such as actionable insights. For example, gamification solution components can be implemented using serverless architecture such as AWS Batch, AWS Lambda, or AWS Step Functions. In this example embodiment, agent performance data and other information collected from end users, such as agents, is transmitted to the serverless architecture in the form of raw data files. These raw data files contain information and values related to various metrics and KPIs for each end user.

Data ingestors ingest the data to aggregate per-agent and per-time period, and transform the data for system use, such as for use in calculating a pursuit effectiveness score. The data is then stored on a database server, which serves to aggregate gamification pursuit data, agent performance data, and any other information that is used by the system or a manager when evaluating an agent's performance. The database is communicatively coupled with the external web applications accessed by the agents, such as to provide pursuit data to be received by agents, as well as with a gamification architecture and pursuit effectiveness architecture utilized to generate pursuits, apply pursuit effectiveness scores, provide modifications to pursuits, provide actionable insights, or otherwise analyze and react to a pursuit. For instance, a pursuit effectiveness score calculator receives data and calculates a pursuit effectiveness score for an agent or for a team of agents as detailed above. This may be triggered by a scheduling component, such as a scheduler, or otherwise may be initiated by the system or a manager or supervisor. Pursuit data, pursuit effectiveness scores, and other information is then provided to an insights and actions automator.

FIG. 7B is an example of the insights and actions automator, according to some embodiments. The insights and actions automator functions to initiate actions to improve agents' performance, generate actionable insights for agents, and generate actionable insights for supervisors and managers, such as when active intervention or other human input is needed with an agent. The insights and actions automator is implemented as part of a serverless architecture and is configured to receive pursuit data and information from a pursuit effectiveness calculator as detailed in FIG. 7A.

The insights and actions automator includes multiple modules, such as an analyzer, actions delegator, and insights generator. The analyzer is the first component invoked when the automator is triggered, receiving pursuit information from the pursuit effectiveness calculator. For example, the information may include a pursuit ID, pursuit effectiveness score, change score, completion score, speed score, participant ID, and manager ID for each participant for a selected pursuit. The analyzer determines actionable insights that should be implemented based on the pursuit effectiveness score ranges, and generates actions and insights, which are passed to the actions delegator and insights generator, respectively.

The actions delegator functions to perform actions determined by the analyzer module and implement the actions within the system. This includes actions such as pursuit creation, rewards assignment, and coaching program creation. Actions are taken by the actions delegator using microservices of the system within which the actions delegator is implemented.

The insights generator functions to generate insights for supervisors or managers. For instance, insights may take the form of small textual notifications shown on a supervisor landing page, sent via email, or otherwise communicated to the supervisors or managers. The insights generator also generates additional actionable insights to be taken related to pursuit creation, coaching program creation, and rewards assignment. Additionally, the insights generator identifies KPI champions, to assign agents as mentors for other agents, and objective calibration, to modify pursuit objective values for a given participant to make a pursuit more attainable.

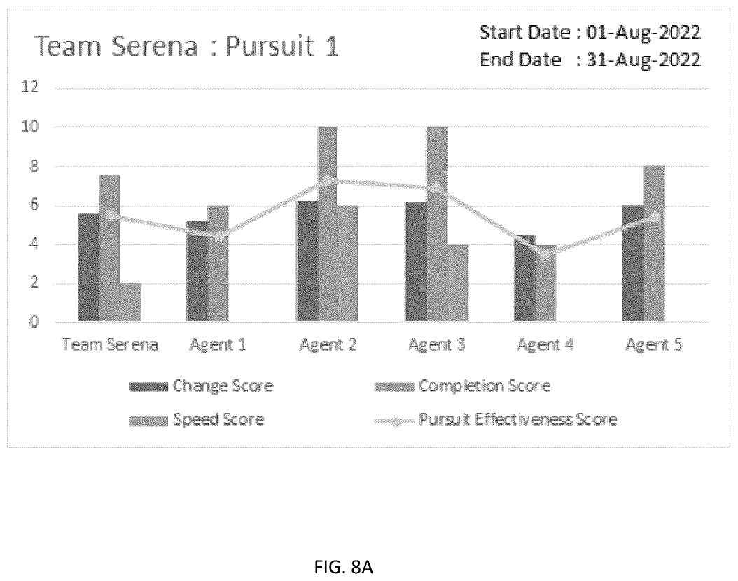

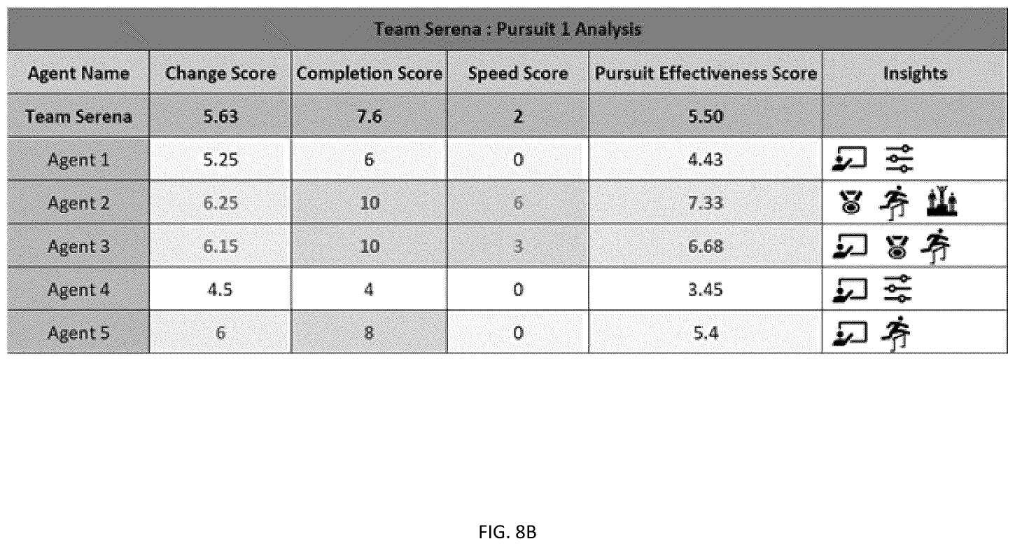

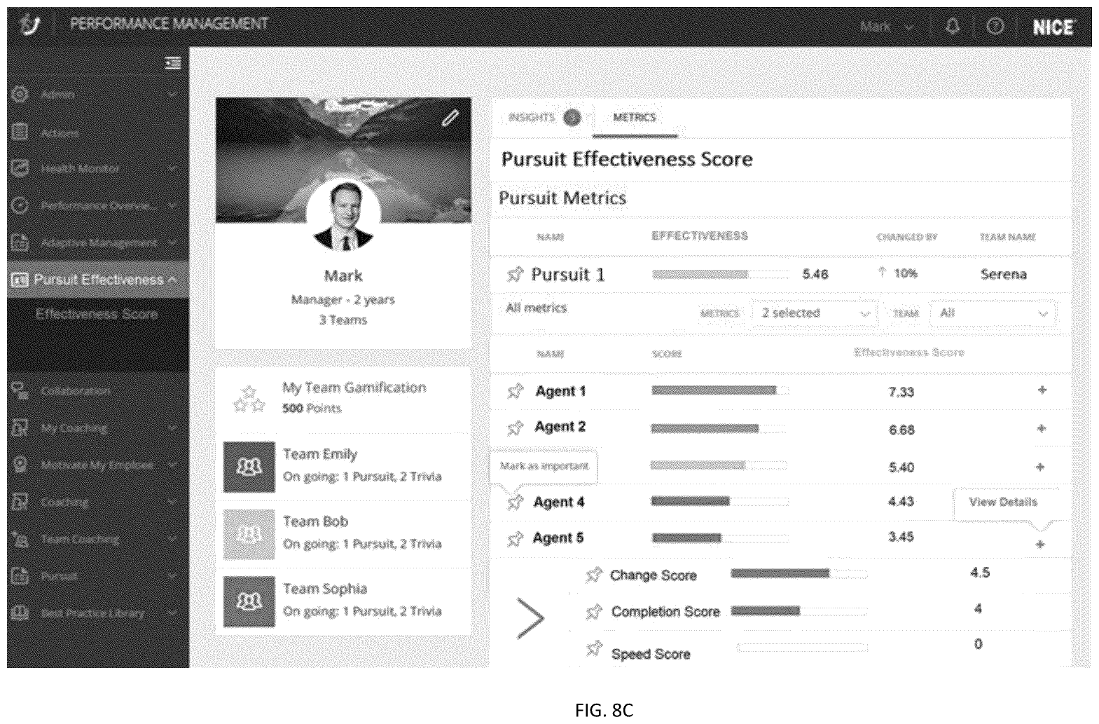

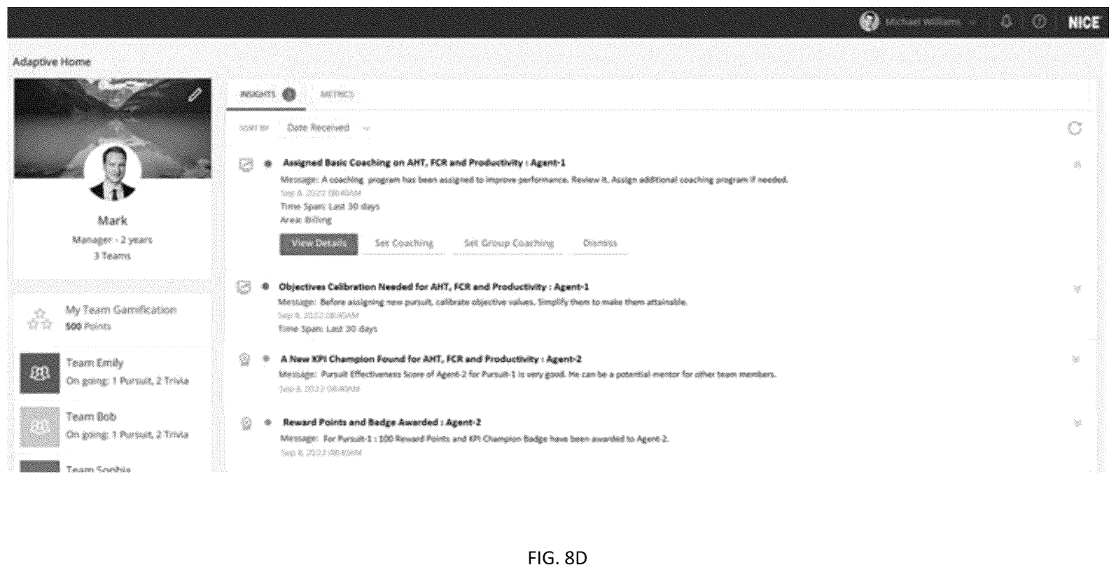

FIG. 8A is an exemplary graph for viewing the pursuit effectiveness scores of agents on a team and a team average, according to some embodiments. In a first example, a manager determines that their team's KPI values are not reaching the desired goals. Table 4, below, provides an example of KPI information received by the manager prior to implementing a pursuit, where average handle time (AHT), first call resolution (FCR), and productivity are the KPIs for which the manager is focusing on:

TABLE 4

| Name | AHT | FCR | Productivity |
|---|---|---|---|
| Team (Avg.) | 350 | 36 | 76 |
| Agent 1 | 229 | 45 | 65 |
| Agent 2 | 292 | 41 | 70 |
| Agent 3 | 379 | 33 | 80 |
| Agent 4 | 360 | 36 | 90 |
| Agent 5 | 493 | 29 | 75 |

After the creation and assignment of the pursuit, the team participates in and completes the pursuit. Following the pursuit end date and end of the post-pursuit monitoring period, the manager then reevaluates the KPI values, shown in table 5, below:

TABLE 5

| Name | AHT | FCR | Productivity |
|---|---|---|---|
| Team (Avg.) | 344 | 37 | 82 |
| Agent 1 | 250 | 42 | 75 |
| Agent 2 | 262 | 45 | 90 |
| Agent 3 | 300 | 39 | 70 |
| Agent 4 | 445 | 28 | 95 |
| Agent 5 | 470 | 30 | 80 |

Utilizing the pursuit information collected, including the information shown in tables 4 and 5 above, the system automatically derives a change score, completion score, speed score, and accordingly, a pursuit effectiveness score according to the formulae detailed above. Using the pursuit effectiveness score, as well as the component scores such as the change score, completion score, and speed score, the manager is able to quickly parse agent performance data, understand which agents are benefiting from the pursuit, and identify which agents are struggling with the pursuit. Based on table 6, below, agent 2 and agent 3 have the best pursuit effectiveness scores and thus the most benefit, while agent 5 has benefitted slightly. However, agent 1 and agent 4 struggled to reach KPI goals and had low pursuit effectiveness scores, which indicates a need for adjustments to the pursuit. The data shown in table 6, below, may further be presented to a supervisor or manager in different formats, such as the bar chart in FIG. 8A.

TABLE 6

| | | | | Pursuit |
|---|---|---|---|---|
| | Change Score | Completion Score | Speed Score | Effectiveness |
| Name | (Weight: 0.5) | (Weight: 0.3) | (Weight: 0.2) | Score |
| Agent 1 | 5.25 | 6 | 0 | 4.43 |
| Agent 2 | 6.25 | 10 | 6 | 7.33 |
| Agent 3 | 6.15 | 10 | 3 | 6.68 |
| Agent 4 | 4.5 | 4 | 0 | 3.45 |
| Agent 5 | 6 | 8 | 0 | 5.40 |

Utilizing the pursuit data, the system generates actionable insights for the agents and manager. Table 7, below, shows an example of actionable insights generated for each agent based on the pursuit effectiveness scores. Based on the insights, the manager can replicate the pursuit for some agents, while have modified pursuits created for other agents to better tailor the pursuits to agent improvement. Additionally, the insights provide information for the manager to pinpoint the KPI values for which each agent can most improve on, as well as ideal difficulty levels for each agent for the KPI values.

TABLE 7
Automated Actions and Insights

| | |
|---|---|
| Agent 1 | Basic Coaching |
| | Pursuit Objective Calibration |
| Agent 2 | Rewards and Badge Assignment |
| | Pursuit Assignment |
| | KPI Champion |
| Agent 3 | Advanced Coaching |
| | Rewards and Badge Assignment |
| | Pursuit Assignment |
| Agent 4 | Basic Coaching |
| | Pursuit Objective Calibration |
| Agent 5 | Advanced Coaching |
| | Pursuit Assignment |

Accordingly, the pursuit effectiveness information allows the manager to pinpoint areas of improvement for specific agents, identify agents that are excelling or falling behind, and assign tailored training to each agent.

FIG. 8B is an exemplary table for viewing the pursuit effectiveness scores of agents on a team, a team average, and actionable insights, according to some embodiments. Utilizing pursuit effectiveness data, such as the data described above with respect to FIG. 8A, the system may instead present information to a manager or supervisor in a table such as FIG. 8B. In such instances, the table may further implement the use of color or other visual indicators to highlight high or low performances, and use symbols or other shorthand to show actionable insights. In some embodiments, a supervisor or manager interacts with the chart to receive additional information regarding each actionable insight through an interaction such as clicking on the insight symbol.

FIG. 8C is an exemplary user interface for a team leader to view pursuit effectiveness scores and related data, according to some embodiments. This is an alternative view that is presented to supervisors and managers to view individual agent pursuit effectiveness scores and team pursuit effectiveness scores, as implemented within a serverless architecture as discussed above with respect to FIGS. 7A-7B.

FIG. 8D is an exemplary user interface for interacting with actionable insights generated by a system utilizing pursuit effectiveness scores, according to some embodiments. Insights and other information that is useful for managers and supervisors that is generated according to the embodiments described above are sent and integrated within a serverless architecture as discussed above with respect to FIGS. 7A-7B.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

What is claimed is:

1. A method of providing feedback to a contact center agent, comprising:
selecting a contact center agent from a plurality of contact center agents;
performing an evaluation of the agent, wherein the evaluation comprises:
selecting one or more agent skills from a plurality of agent skills assigned to the call center agent;
identifying one or more key performance targets for the agent;
assigning a key performance indicator (KPI) value to one or more of the of the key performance targets for the agent;
assigning a pursuit targeted to one or more of the key performance targets, wherein the pursuit comprises one or more objectives to motivate and evaluate the agent;
measuring the KPI values for one or more of the key performance targets for the agent after completion of the pursuit; and
assigning a pursuit effectiveness score to the pursuit, wherein the pursuit effectiveness score is based on a weighted average of a change score representing a change in KPI values from before and after completion of the pursuit, a completion score representing a degree of completion of the pursuit, and a speed score representing the speed with which the pursuit was completed;
determining one or more scoring thresholds;
assigning the agent additional training based on the pursuit effectiveness score and the one or more scoring thresholds, wherein additional training is assigned based on the value of the pursuit effectiveness score compared to the one or more scoring thresholds.

2. The method of claim 1, which further comprises:
repeating the evaluation for each agent on a team of agents;
determining a team average for the team of agents; and
generating a team report for the performance of each agent on the team of agents, wherein each agent on the team of agents is compared to the team average for the team of agents.

3. The method of claim 2, wherein one or more modifications are made to the pursuit based on the team average, wherein the one or more modifications include calibrating objective values to make objectives attainable for the agent.

4. The method of claim 1, wherein assigning the additional training involves determining that the agent scored above the one or more scoring thresholds and modifying the pursuit, wherein the modifications include increasing the difficulty of future pursuits assigned to the agent.

5. The method of claim 1, wherein:
the change score comprises a unified scaled score of change in the KPI values for one or more of the key performance targets for the agent over the duration of the pursuit;
the completion score comprises a scaled score based on the amount of the pursuit completed by the agent; and
the speed score comprises a scaled score of the duration in which the agent took completing the pursuit.

6. The method of claim 5, which further comprises determining that the agent did not fully complete the pursuit, and assigning a zero to the speed score.

7. The method of claim 1, wherein the KPI values each comprise a score for average handling time, first call resolution, sentiment, talk time, or silence time, or a combination thereof.

8. The method of claim 1, wherein the one or more scoring thresholds comprises a first scoring threshold and a second scoring threshold, wherein a first performance zone is established for scores below the first scoring threshold and second scoring threshold, a second performance zone is established for scores above the first scoring threshold and below the second scoring threshold, and a third performance zone is established for scores above the first scoring threshold and second scoring threshold.

9. The method of claim 8, wherein the additional training is assigned to the agent based on which of the scoring thresholds the pursuit effectiveness score is in, wherein the difficulty of the training is scaled based on the scoring threshold.

10. A system of providing feedback to a contact center agent, which comprises:
a processor and computer readable medium operably coupled thereto, the computer readable medium comprising a plurality of instructions stored in association therewith that are accessible to, and executable by, the processor, to provide feedback to the contact center agent by:
selecting a contact center agent from a plurality of contact center agents;
performing an evaluation of the agent, wherein the evaluation comprises:
selecting one or more agent skills from a plurality of agent skills assigned to the call center agent;
identifying one or more key performance targets for the agent;
assigning a key performance indicator (KPI) value to one or more of the of the key performance targets for the agent;
assigning a pursuit targeted to one or more of the key performance targets, wherein the pursuit comprises one or more objectives to motivate and evaluate the agent;
measuring the KPI values for one or more of the key performance targets for the agent after completion of the pursuit;
assigning a pursuit effectiveness score to the pursuit, wherein the pursuit effectiveness score is based on a weighted average of a change score representing a change in KPI values from before and after completion of the pursuit, a completion score representing a degree of completion of the pursuit, and a speed score representing the speed with which the pursuit was completed;
determining one or more scoring thresholds;
assigning the agent additional training based on the pursuit effectiveness score and the one or more scoring thresholds, wherein additional training is assigned based on the value of the pursuit effectiveness score compared to the one or more scoring thresholds.

11. The system of claim 10, which further comprises:
repeating the evaluation for each agent on a team of agents;
determining a team average for the team of agents; and
generating a team report for the performance of each agent on the team of agents, wherein each agent on the team of agents is compared to the team average for the team of agents.

12. The system of claim 11, wherein one or more modifications are made to the pursuit based on the team average, wherein the one or more modifications include calibrating objective values to make objectives attainable for the agent.

13. The system of claim 10, wherein assigning the additional training involves determining that the agent scored above the one or more scoring thresholds and modifying the pursuit, wherein the modifications include increasing the difficulty of future pursuits assigned to the agent.

14. The system of claim 10, wherein:
the change score comprises a unified scaled score of change in the KPI values for one or more of the key performance targets for the agent over the duration of the pursuit;
the completion score comprises a scaled score based on the amount of the pursuit completed by the agent; and
the speed score comprises a scaled score of the duration in which the agent took completing the pursuit.

15. The system of claim 14, which further comprises determining that the agent did not fully complete the pursuit, and assigning a zero to the speed score.

16. The system of claim 10, wherein the KPI values each comprise a score for average handling time, first call resolution, sentiment, talk time, or silence time, or a combination thereof.

17. The system of claim 10, wherein the one or more scoring thresholds comprises a first scoring threshold and a second scoring threshold, wherein a first performance zone is established for scores below the first scoring threshold and second scoring threshold, a second performance zone is established for scores above the first scoring threshold and below the second scoring threshold, and a third performance zone is established for scores above the first scoring threshold and second scoring threshold.

18. The system of claim 17, wherein the additional training is assigned to the agent based on which of the scoring thresholds the pursuit effectiveness score is in, wherein the difficulty of the training is scaled based on the scoring threshold.

19. A non-transitory computer-readable medium having stored thereon computer-readable instructions executable to provide feedback to a contact center agent, in which the computer-readable instructions to provide feedback to a contact center agent comprises:
selecting a contact center agent from a plurality of contact center agents;
performing an evaluation of the agent, wherein the evaluation comprises:
selecting one or more agent skills from a plurality of agent skills assigned to the call center agent;
identifying one or more key performance targets for the agent;
assigning a key performance indicator (KPI) value to one or more of the of the key performance targets for the agent;
assigning a pursuit targeted to one or more of the key performance targets, wherein the pursuit comprises one or more objectives to motivate and evaluate the agent;
measuring the KPI values for one or more of the key performance targets for the agent after completion of the pursuit;
assigning a pursuit effectiveness score to the pursuit, wherein the pursuit effectiveness score is based on a weighted average of a change score representing a change in KPI values from before and after completion of the pursuit, a completion score representing a degree of completion of the pursuit, and a speed score representing the speed with which the pursuit was completed;
determining one or more scoring thresholds;
assigning the agent additional training based on the pursuit effectiveness score and the one or more scoring thresholds, wherein additional training is assigned based on the value of the pursuit effectiveness score compared to the one or more scoring thresholds.

20. The non-transitory computer-readable medium of claim 19, wherein:
the change score comprises a unified scaled score of change in the KPI values for one or more of the key performance targets for the agent over the duration of the pursuit;
the completion score comprises a scaled score based on the amount of the pursuit completed by the agent; and
the speed score comprises a scaled score of the duration in which the agent took completing the pursuit.
